(19) United States
(12) Patent Application Publication
(10) Pub. No.: US 2026/0350810 A1
(43) Pub. Date: Nov. 5, 2026

(54) NON-CONTACT METHOD FOR PIG WEIGHT MEASUREMENT BASED ON CONTOUR INFORMATION WITH TWO-DIMENSIONAL IMAGES

(71) Applicant: HUAZHONG AGRICULTURAL UNIVERSITY, Wuhan (CN)

(72) Inventors: Tao XIANG, Wuhan (CN); Ximing DONG, Wuhan (CN); Gang Jun Tu, Wuhan (CN); Shuhong ZHAO, Wuhan (CN)

(73) Assignee: HUAZHONG AGRICULTURAL UNIVERSITY, Wuhan (CN)

(21) Appl. No.: 19/333,245

(22) Filed: Sep. 18, 2025

Related U.S. Application Data
(63) Continuation of application No. PCT/CN2024/128322, filed on Oct. 30, 2024.

(30) Foreign Application Priority Data
Oct. 22, 2024 (CN) 202411471521.5

(51) Int. Cl. G06T 7/13; G01G 17/08; G06K 7/10; G06T 3/4084

(52) U.S. Cl. CPC G06T 7/13; G01G 17/08; G06K 7/10297; G06T 3/4084; G06T 2207/10016; G06T 2207/20016; G06T 2207/20052; G06T 2207/20081; G06T 2207/20084; G06T 2207/30204

(57) ABSTRACT

A non-contact pig weight measurement method based on contour information with two-dimensional (2D) images, comprising the following steps: a. Data acquisition: Acquiring 2D images of pig backs using overhead cameras; streaming video via RTSP; filtering similar frames with perception hashing; obtaining pig IDs through RFID and correlating them with visual markers on pig backs; b. Contour extraction: Extract contour information of pig backs from the acquired images using a contour extraction network. c. Weight measurement: Predict pig weight based on the refined contour information using a live-weight estimation network. The present invention enables real-time pig weight measurement in practical production environments without restricting pig movement or requiring specific postures. The method imposes zero stress on pigs while achieving high efficiency and accuracy.

### CROSS-REFERENCE TO RELATED APPLICATIONS

The application claims priority to Chinese patent application No. 202411471521.5, filed on Oct. 22, 2024, the entire contents of which are incorporated herein by reference.

### TECHNICAL FIELD

The present invention relates to the technical field of intelligent livestock farming, and specifically discloses a non-contact pig weight measurement method based on contour information with two-dimensional (2D) images.

### BACKGROUND

Pig weight serves as a critical metric in livestock farming operations, directly impacting farm profitability, production costs, and pork quality. Frequent weight monitoring is essential throughout pig rearing cycles. Traditional weight measurement relies on manual weighing, requiring direct physical contact. With advancements in intelligent livestock farming technologies, non-contact weight measurement has emerged, offering significant advantages over conventional methods. It eliminates physical contact, reducing animal stress and potential injuries; minimizes time for monitoring and data collection; and decreases labor requirements and associated costs. Currently, non-contact weight measurement methods bifurcate into two technical approaches: morphological methods and deep learning-based methods.

Morphological methods focus on extracting pig morphological characteristics (e.g., body length, body width) and establishing regression equations for weight measurement. These methods require: specific postures to be maintained by pig, constrained positioning within defined areas, and particularly stringent requirements for 2D image acquisition. Such limitations significantly compromise practical applicability and operational flexibility in commercial farming environments.

Deep learning-based methods overcome these limitations by utilizing entire pig images or segmented image regions as input data, enabling unconstrained posture weight measurement. However, this approach exhibits notable drawbacks: dependence on deep neural networks for learning and inference; increased computational latency, preventing real-time measurement; and requirement for dedicated hardware, elevating farm operational costs.

### SUMMARY

### Technical Problem

Existing non-contact weight measurement methods in the existing technologies still suffer from several technical limitations that hinder their deployment in practical farming environments. These include: requiring constrained pig movement; needing specific postures to be maintained; and failing to achieve real-time monitoring of pig weight in actual production settings.

### Technical Solution

The present invention aims to overcome the deficiencies of existing technologies by providing a non-contact pig weight measurement method based on contour information with 2D images. This method enables: real-time monitoring of pig weight in actual production environments; no constraint on pig movement; and no requirement for specific postures.

The object of the present invention is achieved through the following technical solution: a non-contact pig weight measurement method based on contour information with 2D images, comprising the following steps:
a) Data acquisition:
a1. Capture 2D images of pig backs using cameras mounted above pig pens; Stream camera feeds via the RTSP protocol; Filter similar frames in video streams using perception hashing technology to obtain pig images and visual markers on pig backs;
a2. Acquire pig IDs via Radio Frequency Identification (RFID) and record them in a database;
a3. Correlate visual markers on pig backs to assign IDs to individual pig.
b. Contour extraction:
b1. Process images using a lightweight backbone network to obtain multi-resolution feature sets, then fuse features via iterative deep aggregation to generate feature maps;
b2. Generate pig center heatmaps and contour coordinate maps by processing feature maps through convolutional layers, then derive initial contour information of each pig via center regression;
b3. Extract features corresponding to initial contours, normalize them as positional encodings, concatenate with features, and process through multi-head self-attention layers to obtain initial contour offsets, yielding refined pig back contours;
c. Weight measurement:
c1. Perform image normalization and self-normalization on refined pig back contours, then concatenate the processed information;
c2. Apply linear projection to map above information to high-dimensional space;
c3. Fuse information and capture dependencies via multi-head self-attention mechanisms;
c4. Reduce dimensionality through adaptive average pooling;
c5. Predict pig weight via fully connected layer regression.
characterized in that in step a1, the perception hashing technology comprises the following steps:
Convert the n-th frame image Iₙ to a grayscale image and resize the image to 32× 32; Apply a Discrete Cosine Transform (DCT) and extract the top-left 8× 8 coefficient matrix Cᵢⱼ;
Compute a mean value μ of the coefficients Cᵢⱼ and apply thresholding to generate a hash string:
Hₙ={hₙ(ij), i=0,1, . . . , 7, j=0, 1, . . . , 7}, Where,

$${h}_{n} ( i j ) = \{ \begin{matrix}0 , & {C}_{i j} \leq μ : \\ 1 , & otherwise :\end{matrix}$$

Process the (n+1)-th frame image Iₙ₊₁ using the identical steps described above to obtain Hₙ₊₁, then compute the similarity S between the two hash strings using Hamming distance:

$$𝒮 = {\sum }_{i = 0}^{7} {\sum }_{j = 0}^{7} {h}_{n} ( ij ) XOR {h}_{n + 1} ( i j )$$

If the similarity [symbol] exceeds 15, the frames are deemed dissimilar; otherwise, the current frame is filtered out and the next frame is captured to repeat all aforementioned steps.

In step a1, the visual marker comprises a coordinate set of N points uniformly sampled from the pig back contour

$${\{ {x}_{i} , {y}_{i} \}}_{i = 1}^{N} .$$

In step a2, the pig IDs obtained using Radio Frequency Identification (RFID) technology comprises reading RFID data from pig ear tags via an ear tag reader.

It further comprise step a4: acquiring pig weight measurements using a floor scale, and generating labeled datasets by associating the weight measurements with corresponding pig images and IDs for subsequent network training.

In step c, the refined pig back contour information comprises a coordinate set of N points uniformly sampled from the pig back contour

$${\{ {x}_{i} , {y}_{i} \}}_{i = 1}^{N} .$$

In the contour extraction step, the present invention employs a Contour Information Extraction Network (CIEN) to acquire pig back contour information. The network initializes contour information and iteratively refines coarse contour to achieve high-efficiency pig contour extraction. The method introduces a Contour Self-attention Mechanism that: normalizes contour coordinates as positional encodings, and concatenates these encodings with contour features. It then processes the combined data through multi-head self-attention layers to predict contour offsets and generates final refined contours.

In the weight measurement step, the present invention employs a Live-Weight Estimation Network (LWEN) to directly determine pig weight using back contour information. This network: discards conventional CNN architectures prevalent in existing research; processes pig back contour information as direct input; requires only minimal computational operations for weight determination; and eliminates resource-intensive convolutional layer calculations.

### Advantageous Effects

The present invention achieves the following technical advantages: without constraining pig movement; no requirement for specific postures; applicable to freely moving/feeding pigs in actual production environments; and zero physical stimulation to pigs. The present invention delivers rapid, efficient, and highly accurate real-time pig weight monitoring. By utilizing 2D image-based non-contact weight measurement, it significantly reduces computational costs. The invention is scalable for mass deployment in practical pig farming operations, providing data-driven decision support for commercial pork production enterprises.

### BRIEF DESCRIPTION OF DRAWINGS

FIG. 1 is a block diagram illustrating the operational principle of the present invention;

FIG. 2 is a block diagram showing the data acquisition principle;

FIG. 3 is a block diagram demonstrating the contour extraction principle;

FIG. 4 is a block diagram depicting the weight measurement principle.

### DETAILED DESCRIPTION OF THE EMBODIMENTS

The following is the detailed description with reference to the drawings.

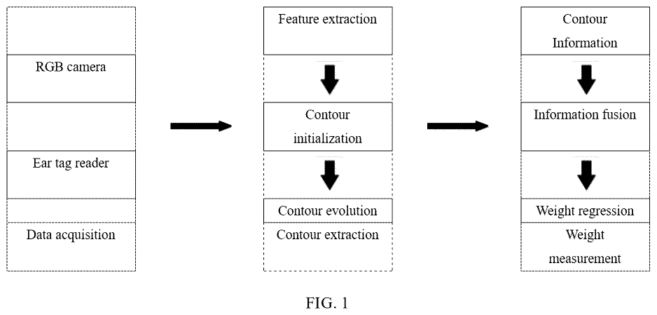

As shown in FIG. 1, a non-contact pig weight measurement method based on contour information with 2D images comprises: data acquisition, contour extraction, and weight measurement. Wherein: the data acquisition process is implemented by RGB cameras and ear tag readers; The contour extraction comprises feature extraction, contour initialization, and contour evolution; The weight measurement comprises information fusion of contour information, and regression analysis for pig weight determination.

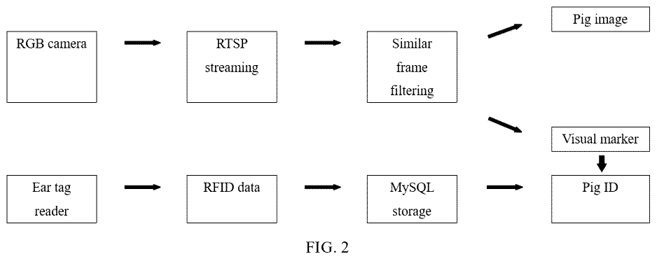

As shown in FIG. 2, the data acquisition process comprises the following steps:
Install RGB cameras above pig pens; Mark pig IDs on pig backs using marking tools (e.g., wax pencils); Obtain video streams via the RTSP protocol; Filter similar frames using perception hashing algorithms:
Convert the n-th frame image Iₙ to a grayscale image and resize the image to 32×32, yielding

$${I}_{n}^{′} ;$$

Apply a Discrete Cosine Transform (DCT) to the image

$${I}_{n}^{′}$$

and extract the top-left 8× 8 coefficient matrix Cᵢⱼ;
Compute the mean value u of the coefficient matrix, set coefficients>μ to 1 and set coefficients≤μ to 0 to generate two 64-bit hash strings Hₙ={hₙ(ij), i=0, 1, . . . , 7, j=0, 1, . . . , 7}, where,

$${h}_{n} ( i j ) = \{ \begin{matrix}0 , & if {C}_{i j} \leq μ : \\ 1 , & otherwise :\end{matrix}$$

Apply the identical procedure to the (n+1)-th frame image Iₙ₊₁, obtaining its hash string Hₙ₊₁;
The Hamming distance [symbol] between the two hash strings is computed as:

$$𝒮 = {\sum }_{i = 0}^{7} {\sum }_{j = 0}^{7} {h}_{n} ( ij ) XOR {h}_{n + 1} ( i j )$$

If the Hamming distance [symbol] >15, the frames are deemed dissimilar; Otherwise, the current frame is filtered out;
Following similar frame filtration, the system acquires pig images and visual marker information on pig backs.

Read pig ear tag data using an RFID ear tag reader; Store the data in a MySQL database; Correlate the RFID data with visual markers on pig backs to assign pig IDs in the images. Then acquire pig weight measurements using a floor scale or equivalent tools; Label the data by associating pig images and IDs; Generate annotated datasets for subsequent neural network training.

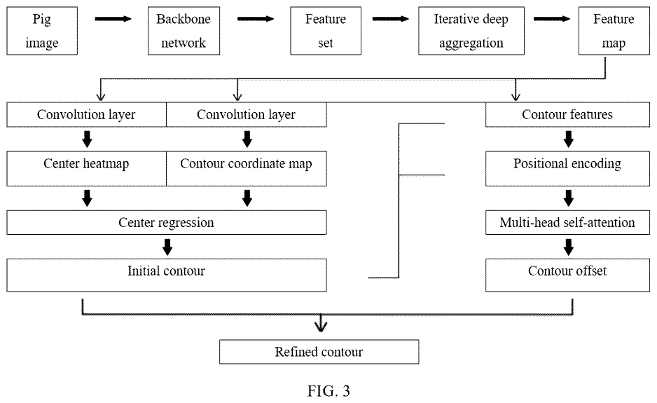

As shown in FIG. 3, the contour extraction step comprises the following sub-steps:
Input pig images into the lightweight backbone network MobileNetV2 to generate feature sets;
Apply iterative deep aggregation technology to generate a feature map [symbol] with spatial dimensions 4× downsampled relative to the input image.

Process [symbol] through separate convolutional layers to generate center heatmap and contour coordinate map; then execute center regression to derive initial pig contour coordinate set

$${\{ {x}_{i} , {y}_{i} \}}_{i = 1}^{N} ;$$

Normalize

$${\{ {x}_{i} , {y}_{i} \}}_{i = 1}^{N}$$

to obtain positional encodings

$${\{ {x}_{i}^{′} , {y}_{i}^{′} \}}_{i = 1}^{N} :$$

$${x}_{i}^{′} = \frac{{x}_{i} - {x}_{min}}{{x}_{max} - {x}_{min}} , {y}_{i}^{′} = \frac{{y}_{i} - {y}_{min}}{{y}_{max} - {y}_{min}} ,$$

Where, xₘᵢₙ and yₘᵢₙ represent the minimum values; xₘₐₓ and yₘₐₓ represent the maximum values;
Extract contour features [symbol] from [symbol] based on

$${\{ {x}_{i} , {y}_{i} \}}_{i = 1}^{N} ;$$

Concatenate the contour features [symbol] , and positional encodings

$${\{ {x}_{i}^{′} , {y}_{i}^{′} \}}_{i = 1}^{N} .$$

along the feature dimension, and use a multi-head self-attention mechanism to fuse information and capture dependencies;

Obtain contour offsets

$${\{ Δ {x}_{i} , Δ {y}_{i} \}}_{i = 1}^{N} ,$$

add the offsets to the initial contour coordinates to generate refined contours.

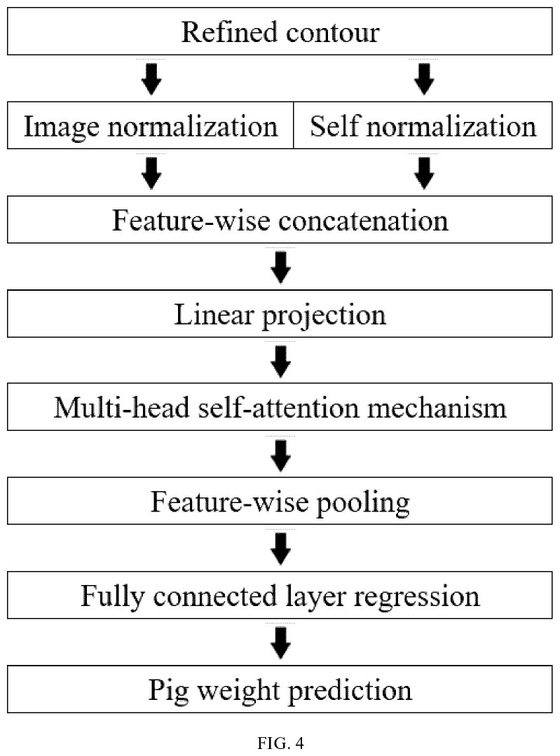

As shown in FIG. 4, the weight estimation process comprises the following steps:

Utilize the above refined contour coordinates

$$𝒳 = {\{ {x}_{i} , {y}_{i} \}}_{i = 1}^{N}$$

and perform image-relative normalization and self-normalization, where the images are normalized as:

$${\{ \frac{{x}_{i} - W}{W} , \frac{{y}_{i} - H}{H} \}}_{i = 1}^{N}$$

Where, W and H represent the width and height of the image, respectively. Self-normalization follows the same method as implemented in the contour extraction module;

Concatenate the two normalized features to generated input features χ^{norm};

Project the input features χ^{norm} into a higher-dimensional space via linear transformation to generate high-dimensional features χ^{lp}:

χ^{lp}=χ^{norm}χ^{lp},
Where .χ^{lp}. denotes the learnable parameter matrix;
Input high-dimensional features χ^{lp} into a multi-head self-attention mechanism to perform feature fusion and learning;
Apply adaptive pooling along the feature dimension to the output feature matrix .χ^{mhsa} to obtain dimension-reduced features χ^{ld};
Determine the pig weight LW by performing regression on the dimension-reduced features χ^{ld} using a fully connected layer, expressed as:

LW=(LeakyReLU(χ^{ld}W^{fc1}))W^{fc2},

Where, LeakyReLU is the activation function. W^{fc1} and W^{fc2} are learnable parameter matrices of the two fully connected layers.

The foregoing description serves only to illustrate the technical solutions of the present invention and shall not be construed as limiting the scope of protection. Any simple modifications or equivalent substitutions made to the technical solutions by those skilled in the technology without departing from the essence and scope of the invention shall fall within the protection of the present invention.

What is claimed is:

1. A non-contact pig weight measurement method based on contour information with 2D images, comprising the following steps:
a. Data acquisition:
a1. Capture 2D images of pig backs using cameras mounted above pig pens; Stream camera feeds via the RTSP protocol; Filter similar frames in video streams using perception hashing technology to obtain pig images and visual markers on pig backs;
a2. Acquire pig IDs via Radio Frequency Identification (RFID) and record them in a database;
a3. Correlate visual markers on pig backs to assign IDs to individual pig;
b. Contour extraction:
b1. Process images using a lightweight backbone network to obtain multi-resolution feature sets, then fuse features via iterative deep aggregation to generate feature maps;
b2. Generate pig center heatmaps and contour coordinate maps by processing feature maps through convolutional layers, then derive initial contour information of each pig via center regression;
b3. Extract features corresponding to initial contour information, normalize them as positional encodings, concatenate with features, and process through multi-head self-attention layers to obtain initial contour offsets, yielding refined pig back contour information;
c. Weight measurement:
c1. Perform image normalization and self-normalization on refined pig back contours, then concatenate the processed information;
c2. Apply linear projection to map above information to high-dimensional space;
c3. Fuse information and capture dependencies via multi-head attention mechanisms;
c4. Reduce dimensionality through adaptive average pooling;
c5. Predict pig weight via fully connected layer regression.

2. A non-contact pig weight measurement method based on contour information with 2D images according to claim 1, characterized in that in step a1, the perception hashing technology comprises the following steps:
Convert the n-th frame image Iₙ to a grayscale image and resize the image to 32o a; Apply a Discrete Cosine Transform (DCT) and extract the top-left 8×8 coefficient matrix Cᵢⱼ; Compute a mean value μ of the coefficient matrix Cᵢⱼ and apply thresholding to generate a hash string:
Hₙ={hₙ(ij), i=0,1, . . . ,7, j=0,1, . . . ,7}, Where,
$${h}_{n} ( i j ) = \{ \begin{matrix}0 , & if {C}_{i j} \leq μ ; \\ 1 , & otherwise ;\end{matrix} ;$$
Process the (n+1)-th frame image Iₙ₊₁ using the identical steps described above to obtain Hₙ₊₁, then compute the similarity [symbol] between the two hash strings using Hamming distance:
$$𝒮 = {\sum }_{i = 0}^{7} {\sum }_{j = 0}^{7} {h}_{n} ( ij ) XOR {h}_{n + 1} ( i j )$$
If the similarity [symbol] exceeds 15, the frames are deemed dissimilar; otherwise, the current frame is filtered out and the next frame is captured to repeat all aforementioned steps.

3. A non-contact pig weight measurement method based on contour information with 2D images according to claim 1, characterized in that in step a1, the visual marker information comprises pig IDs marked on the pig backs using spray paint or marker pens.

4. A non-contact pig weight measurement method based on contour information with 2D images according to claim 1, characterized in that in step a2, the pig IDs obtained using Radio Frequency Identification (RFID) technology comprises reading RFID data from pig ear tags via an ear tag reader.

5. A non-contact pig weight measurement method based on contour information with 2D images according to claim 1, characterized in that it further comprise step a4: acquiring pig weight measurements using a floor scale, and generating labeled datasets by associating the weight measurements with corresponding pig images and IDs for subsequent network training.

6. A non-contact pig weight measurement method based on contour information with 2D images according to claim 1, characterized in that in step c, the refined pig back contour information comprises a coordinate set of N points uniformly sampled from the pig back contour
$${\{ {x}_{i} , {y}_{i} \}}_{i = 1}^{N} .$$
